(19) United States
(12) Patent Application Publication
(10) Pub. No.: US 2005/0066076 A1
(43) Pub. Date: Mar. 24, 2005

(54) Method for fast recovery of I/O failure on a file system

(75) Inventors: Steven Francis Best, Georgetown, TX (US); Michael Richard Cooper, Austin, TX (US)

Correspondence Address: BRACEWELL & PATTERSON, L.L.P., P.O. BOX 969, AUSTIN, TX, 78767-0969, US

(73) Assignee: International Business Machines Corporation, Armonk, NY (US)

(21) Appl. No.: 10/666,795

(22) Filed: Sep. 18, 2003

(51) Int. Cl. G06F 13/00

(52) U.S. Cl. 710/33

(57) ABSTRACT

A method for enabling dynamic response to I/O failure caused by an out-of-space condition in a file system hosted on a logical volume. An I/O failure response (FR) daemon is implemented to bridge operations between the Logical Volume Manager (LVM) executing in user space and I/O control functions executing in the kernel space. When the file system does not have sufficient space to complete an I/O, the I/O controller signals the I/O FR daemon, which executes the following sequence of operations: (1) alert the LVM that the file system requires additional space; (2) provide a notification to the application level about the resizing; and (3) re-start the I/O operation once the resizing operation completes. The LVM receives the alert and initiates an automatic expansion of the file system to include additional storage space from reserve space on the volume group. The I/O is completed once the expansion operation completes.

### BACKGROUND OF THE INVENTION

1. Technical Field

The present invention relates to data processing and, in particular, to operations involving file systems of data processing systems. Still, more particularly, the present invention relates to managing file systems during I/O failure caused by insufficient storage space in the file system.

2. Description of the Related Art

Management of a computer system's physical memory requires dividing the physical memory into manageable sections, assigning physical addresses to those sections, and mapping those physical addresses to logical addresses. Additionally, management includes providing input/output (I/O) support for applications that typically operate with the logical addresses in application space.

In currently available computer systems, the management of the physical memory includes combining direct access storage devices (DASD) (also referred to as hard disks) into groups called logical volumes. Software known as logical volume managers (LVM), or simply volume managers, manages the logical volumes. The volume manger combines multiple hard disks into a single volume and links the computer system's kernel to the volume. The volume manager then partitions the volume into multiple partitions, which is described in detail in “The Logical Volume Manager (LVM)” authored by Michael Hasenstein (SuSE Inc., 2001) and incorporated herein by reference. FIG. 1 illustrates a series of hard disk drives (or physical volumes) 110 that are combined by a volume manager to provide volume groups 112 having logical volumes 114 that are partitioned according to known methods. The physical volumes 110 are completely hidden to the system behind an LVM abstraction layer in the computer system's kernel. Each of the two illustrated volume groups 112 is partitioned by the LVM into a number of logical volumes 114.

In addition to the above capabilities of the LVM, another functional feature provided by conventional LVMs is the ability to add storage space to existing logical volumes during runtime and subsequently making the additional space immediately available. This expansion capability requires that the volume group being targeted contain an additional storage area that is not already allocated to a different application or file system. One drawback with this capability of the LVM is that its implementation requires all operations accessing the volume group, including the one that may have triggered the need for additional space, to be halted and a failure message to be displayed.

The halting of storage operations due to insufficient space within a logical volume commonly occurs during I/O operations directed at a file system being hosted within the logical volume. File systems and their functional application and use are generally known in the art. With computer systems having volume groups, each file system maps to one of the logical volumes (having a pre-established amount of storage space) within a particular volume group.

Several of the steps involved in setting up the logical volume (A), assigning file systems to specific partitions (B) and then later expanding a partition to accommodate an I/O from an application accessing the file system (C) are indicated below divided into respective sections A, B and C.

A. Set up of logical volumes
1) LVM creates physical volume;
2) LVM creates volume group; and
3) LVM creates logical volume with reserve space to extend the logical volume.

B. Set up and access of file system
4) File system management function (referred to herein as file system manger) formats the logical volume for file system use within the assigned logical boundaries; and
5) File system manager enables mounting of the file system by user applications.

C. LVM response to I/O failure
6) User application I/O runs out of space;
7) File system returns out of space error to application (I/O failure);
8) OS halts and discards I/O;
9) LVM extends logical volume;
10) File system manager extends file system into the additional space on the volume; and
11) User application must re-execute the I/O operation.

Section C above demonstrates that the user receives an actual failure of the I/O and must re-execute the I/O to complete it. Thus, whenever a database supporting the file system fails an I/O, meaning that the file system does not contain sufficient free space in its allocated storage area during a write operation, the current system (or LVM) response requires the application's I/O operation to be restarted. One problem with having to restart the I/O is that most of the known file systems (e.g., FAT, HPFS, JFS, NTFS, and XFS) do not have the capability to restart an I/O if the file system is full. Thus, a failed I/O may result in the file system shutting down or stalling until a user recognizes the problem of the failed I/O and attempts to retry the I/O. Also, conventional volume managers (e.g., Linux LVM, Linux EVMS, LVM on AIX, LVM on OS/2, and LVM on NT) do not have the ability to automatically grow the volume whep an out-of-space condition exists following a failed I/O condition for a file system.

There is currently no practical way to recover from the above out-of-space I/O error on a file system. Current practice is that the application reports an OUT-OF-DISK SPACE error to the user when performing a file save (or similar) operation. Then, the user initiates the process to grow the logical volume and file system and manually restarts (or re-issues) the I/O operation.

The present invention thus recognizes that it would be beneficial to provide a method and system for automatically responding to a failed I/O due to storage limitations of a file system by automatically growing the volume and the file system and dynamically reissuing the I/O. A method and system that “masks” correctable I/O failure conditions from the application and automatically corrects those conditions and completes the I/O would be a desired improvement. These and other benefits are provided by the invention described herein.

### SUMMARY OF THE INVENTION

Disclosed is a method, system, and computer program product for enabling dynamic response to I/O failure caused by an out-of-space condition in a file system hosted on an expandable logical volume. The logical volume hosting the file system has pre-set logical boundaries, but the volume group contains un-allocated, reserve space. A logical volume manager (LVM) that is capable of expanding the logical boundaries to provide additional storage space within the logical volume is provided. In addition to the LVM, an I/O failure response daemon is provided to coordinate I/O failure response operations. The failure response daemon bridges communication between the kernel space and the application space and communicates with both the LVM and file system manager at the application level and the I/O manager/controller and operating system (OS) at the kernel level.

When an I/O operation is sent to the file system, the I/O manager determines whether there is sufficient available space in the file system to complete the I/O. If there is insufficient space, the file system signals the daemon, which executes the following sequence of operations: (1) alert the LVM that the logical volume and file system need to be expanded; (2) provide a notification to the user that the I/O triggered the operation to increase storage space of the file system; and (3) re-initiate the I/O operation at the kernel level once the expansion operation completes.

The LVM receives the alert from the daemon and automatically initiates an expansion of the logical volume and the file system to include additional storage space from the reserve space. When the expansion completes, the LVM signals the daemon to re-start the I/O operation.

In one embodiment, the LVM expands the logical volume into the available reserve space in pre-established increments. The reserve space may itself be partitioned into equal parts of pre-established sizes. When the pre-established increment is less than the space needed, the expansion process is completed via multiple iterations and continues until the required space is made available or all available reserve space is exhausted.. The file system manager then expands the file system to include the additional space. In another embodiment, additional logic is provided to calculate the specific amount of additional space required to complete the I/O. This calculated value determines how much reserve space to allocate to the logical volume during the single expansion.

While the above operations are being completed, a notification is generated and sent to the application space to inform the user of the file system that the file system was being expanded. In one embodiment, a notification mechanism is also provided to indicate to a user when the file system's storage space is near capacity and whether additional space is available within the volume group. The invention enables an application to dynamically recover from an identified I/O out-of-disk failure and complete the original I/O operation in a seamless manner without user input. The user does not receive I/O failure messages for out-of-space conditions.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram illustrating grouping hard disk drives into volume groups and partitioning volume groups into logical partitions according to the prior art;

FIG. 2 is a block diagram illustrating components of a data processing system within which the features of the invention may advantageously be implemented;

FIG. 3A is a block diagram illustrating a volume group partitioned into logical volumes with a reserve partition according to one embodiment of the invention;

FIGS. 3B, 3C, and 3D are block diagrams illustrating the expansion of a logical volume and associated file system by shifting logical boundaries into a reserve space on the volume group according to one embodiment of the present invention;

FIG. 4 is a block diagram illustrating the I/O failure response daemon bridging communication between components in the application level and the kernel level of the data processing system in accordance with one embodiment of the invention; and

FIG. 5 is a flow chart depicting the process by which volume management enables automatic expansion of a file system when an out-of-space condition is received for an application I/O according to one illustrative embodiment of the present invention.

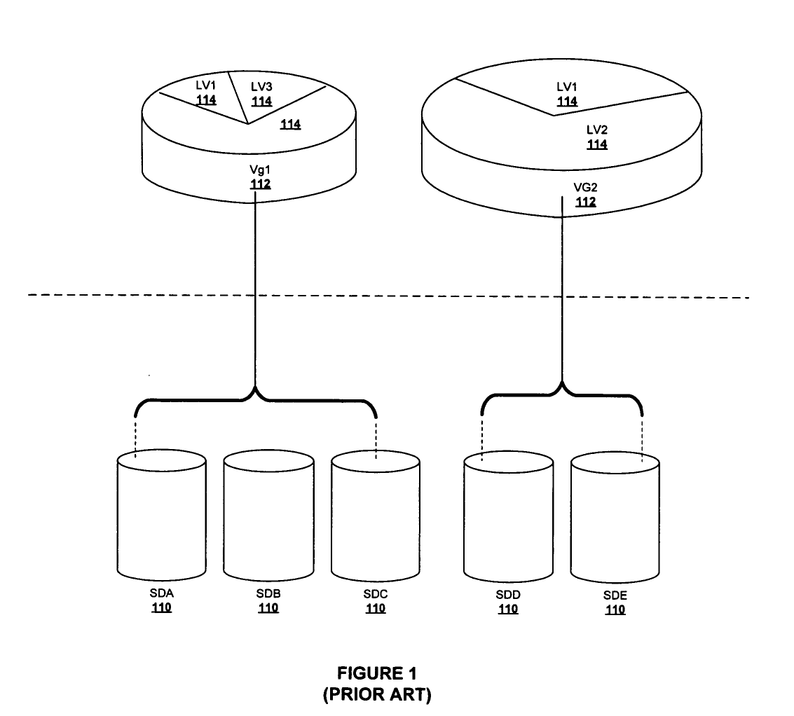

### DETAILED DESCRIPTION OF ILLUSTRATIVE EMBODIMENT(S)

The present invention provides a method and system for automatically responding to a failed I/O due to storage limitations of a file system by automatically growing the volume and the file system and dynamically reissuing/restarting the I/O at the kernel level. Unlike conventional I/O failure response, the present invention enables completion of the application-issued I/O operation without the conventional I/O failure notification and termination of the I/O operation. Implementation of the invention enables a file system to “mask” correctable I/O failure conditions from the application and automatically correct those conditions and complete the I/O.

Further, the invention also provides a functional component that bridges operations between a kernel level and an application level to enable expanding the storage capacity of a logical volume at the application level to accommodate operations being completed at the kernel level in a seamless manner. Additionally, the invention provides a notification mechanism that provides a message/pop-up to the application level stating that the out-of-space condition has occurred and what corrective measures are being complete to correct the out of space condition and complete the I/O.

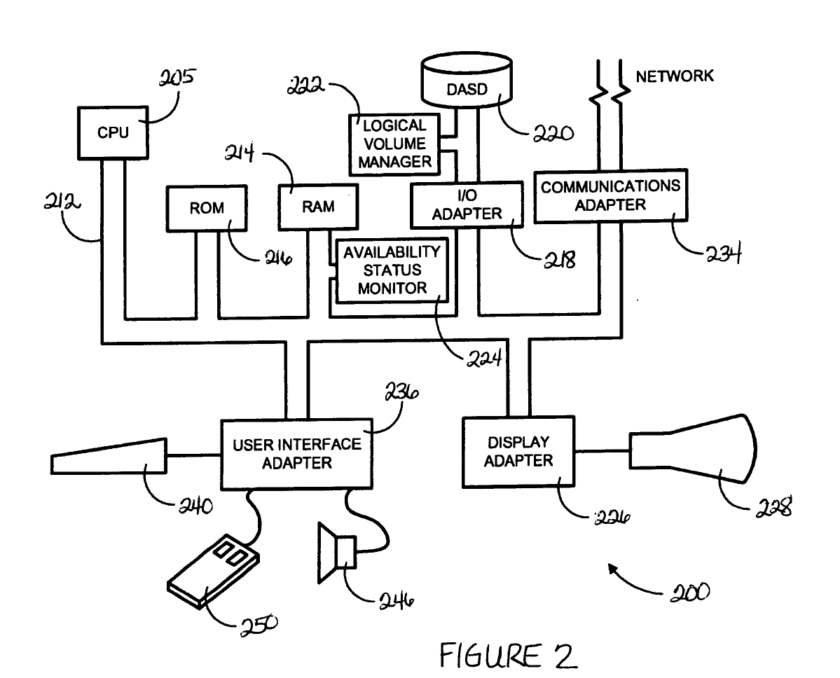

With reference now to the figures and, in particular, with reference to FIG. 2, there is illustrated a block diagram representation of a data processing system (computer system) within which the various processes of the present invention may advantageously be implemented. FIG. 2 is shown for illustrative purposes only and not meant to be limiting on the invention. In particular, a computer system 200 includes any suitable central processing unit (CPU) 205, such as a standard microprocessor, and any number of other objects interconnected by a system bus 212. For purposes of illustration, the computer system 200 includes volatile memory (such as random-access memory (RAM) 214), read-only memory (ROM) 216, and a direct access storage device (DASD) 220 (such as a hard disk drive) having non-volatile memory.

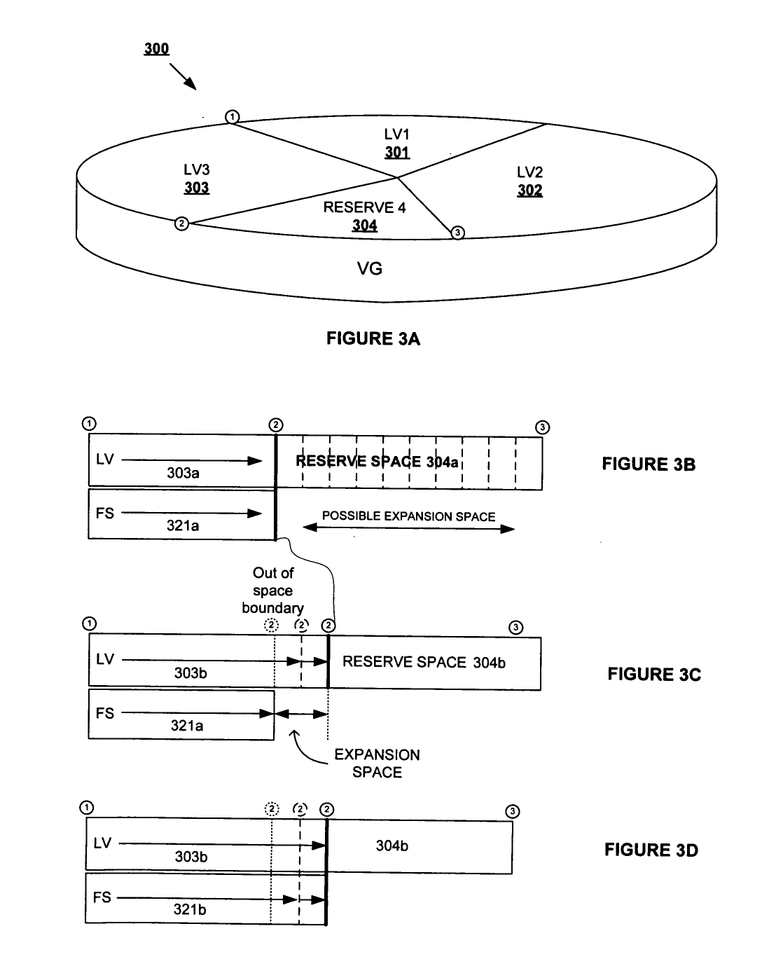

DASK 220 is permanent memory made up of multiple disks or physical volumes 110 that are allocated and controlled by LVM 222. DASD 220 is connected to the system bus 212 by an input/output (I/O) adapter 218. The I/O adapter 218 includes I/O controller, which comprises file system I/O management functions, utilized in the illustrated embodiments to complete various functions of the invention. In the illustrative embodiment of the invention, the physical volumes 110 are combined together to provide one or more volume groups partitioned into logical volumes (see FIG. 3A). Also, according to the embodiments described herein, at least one logical volume hosts a file system and the logical volume is controlled by a logical volume manager (LVM 217). Thus, as illustrated, the computer system 200 also includes a logical volume manager (LVM) 222 to manage the direct access storage device 220 and an availability status monitor 224 in communication with the volatile RAM 114.

Computer system 200 further comprises communications adapter 234, which are connected to system bus 212 and utilized to connect the computer system 200 to a larger computer network. In one embodiment of the invention, data processing system 200 is utilized as a server that is accessible via a network. When data processing system 200 is implemented as a server, remote client systems access the file system via the network.

The computer system 200 further includes a display adapter 226 for connecting the system bus 212 to a suitable display device 228. In addition, a user interface adapter 236 is capable of connecting the system bus 212 to other user interface devices, such as a keyboard 240, a speaker 246, and a mouse 150. In a preferred embodiment, a graphical user interface (GUI) and an operating system (OS) reside within a computer-readable media and contain device drivers that allow one or more users to manipulate object icons and text on the display device 228. Any suitable computer-readable media may retain the GUI and OS, such as, for example, the RAM 214, the ROM 216 and the direct access storage device 220. When operating as a client system, computer system 200 comprises at least one program application 210 utilized mounts the file system to manipulate, delete or add to data stored thereon.

Data processing system may comprise additional hardware and software components, besides those illustrated herein. It is understood that both the components illustrated and particular configuration of these components are provided solely for illustrative purposes and not meant to be limiting on the invention.

The present invention provides a mechanism that allows an application to complete an original I/O operation at a file system without the conventional I/O failure when an out-of-space condition occurs at the file system. The invention is implemented with a volume group, which exhibits the following functional features and provide the specific operating parameters:
(1) The volume group is controlled by a logical volume manager (LVM) that can dynamically increase the size of a logical volume within the volume group;
(2) The volume group contains free space that may be allocated to an expansion operation;
(3) The file system manager is able to dynamically resize/grow the file system, while the file system is mounted and operational; and
(4) The file system manager is also able to restart/continue an I/O that has initially failed without requiring a new I/O be issued from the application.

FIG. 3A illustrates a block diagram of a volume group partitioned into logical volumes. As shown, volume group 300 is partitioned into three named logical volumes, LV1 301, LV2 302, and LV3 303 and a reserve partition 304. Reserve partition 304 is free space that is not presently allocated to any specific one of the logical volumes. Expansion of the logical volumes by the LVM is made possible by the presence within volume group 300 of reserve partition 304.

At least one of the three logical volumes 301-303 hosts an active file system that is accessible via specific applications that may be executing on the computer system 200. The amount of storage space available for the file system correlates to the size of the logical volume and thus, an expansion of the logical volume allows the file system to also be increased in size. In the illustrative embodiment, as described below with reference to FIGS. 3B-3D, LV3 303 hosts a file system and is may be expanded by the LVM to include some or all of the space available in the reserve partition 304.

According to the invention, portions of the reserve partition 304 are allocated by the LVM to the file system of one of the logical volumes when needed to complete an I/O operation. In one embodiment, the reserve partition 304 is itself partitioned into equal blocks of storage space, and the blocks are individually allocated to the logical volume that requires additional space.

I/O Failure Response Daemon

Since operations involving the growing of a volume are easier to complete in user space (i.e., at the application level) rather than in kernel space (at the OS level), the invention provides a function that coordinates I/O failure response operations in the kernel space with those in the user/application space to enable efficient completion of the various steps involved with an I/O failure response. Specifically, a daemon is provided within the OS level to coordinate the communication between user space (application and LVM) and kernel space (OS and 110 controller). The daemon issues a system call to the LVM (user space) to complete the various expansions and then triggers a restart of the I/O operation (OS and I/O controller).

The I/O failure response (FR) daemon comprises programmed functionality that: (1) monitors for a particular signal from the OS or I/O controller that indicates an out-of-space I/O failure has occurred at the file system; (2) issues a command to the LVM at the application level to initiate the expansion of the logical volume and file system; (3) receives a confirmation of the completion of the expansion of the file system; and (4) signals the I/O controller to re-start the I/O at the kernel level. Additionally, in one embodiment, the I/O FR daemon also generates (or triggers the generation of) a notification that is outputted in the user space. This notification alerts a user of the changes being made to the file system (and logical volume) to support the I/O.

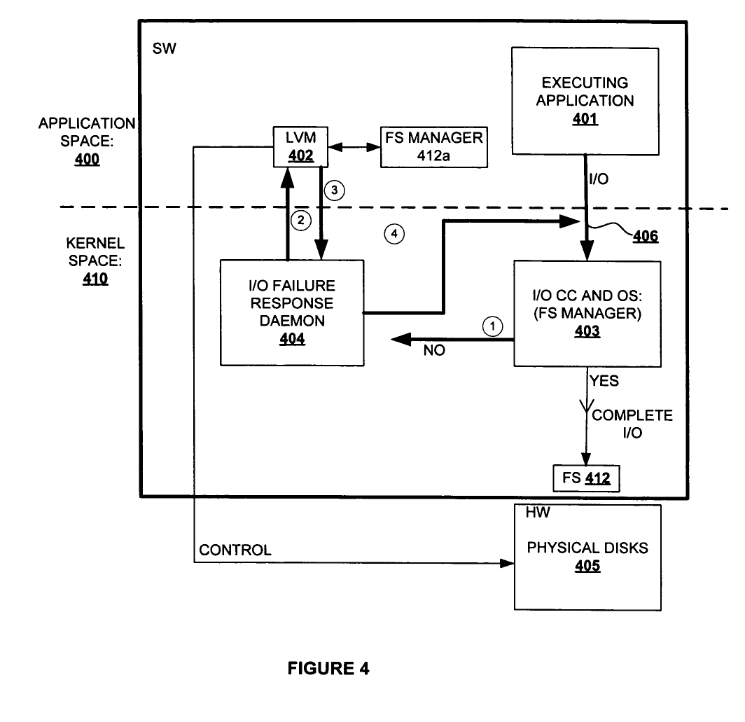

FIG. 4 illustrates a block diagram representation of a failure response daemon operating within the other components of the application space and kernel space to coordinate the I/O failure response, according to the invention. Application space 400 represents the computer system area in which user application 401 and the LVM 402 operate. Kernel space 410, in contrast, represents the area in which the I/O controller that handles I/O operations and I/O FR daemon 404 operate. The kernel space is controlled by the OS, and the I/O controller checks the FS availability.

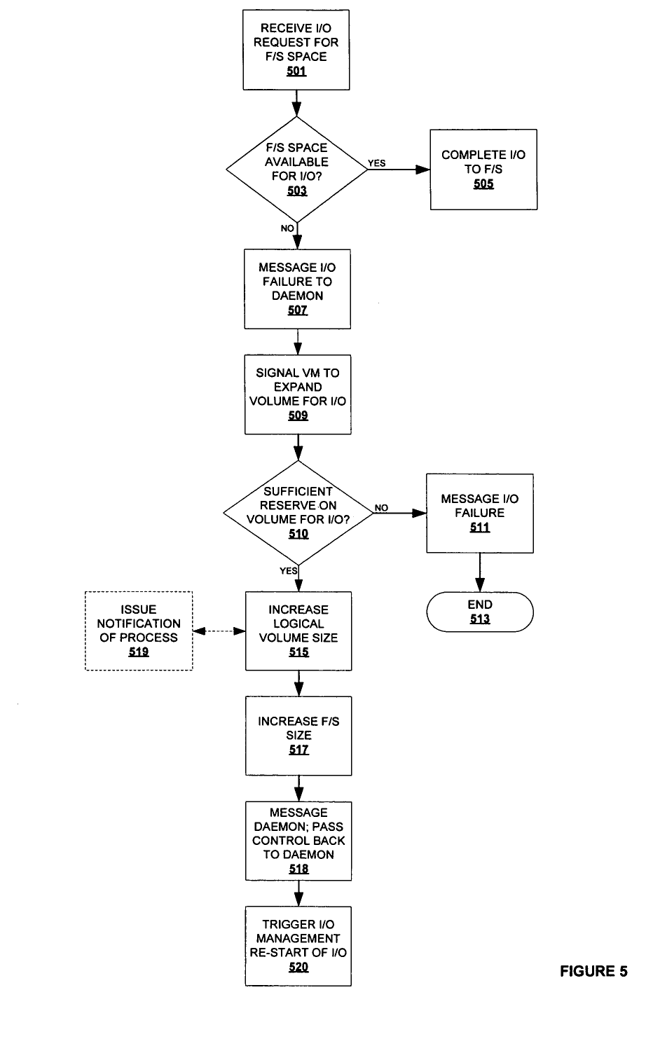

FIG. 5 is a flow chart of the process steps involved in completing the I/O failure response process. The illustrated steps of FIG. 5 are described with reference to the components illustrated within FIG. 4. I/O commands 406 are generated by application 401 in application space 400 and are sent by file system manager to I/O controller in kernel space 410. For clarity of the invention, it is assumed that the I/O command of interest is the write or update operation, which requires some storage space within the file system. The I/O command 406 is received by the I/O controller (step 501), which checks the amount of space required by the I/O and the amount available in the file system.

A determination is made by the file system manager (step 503) whether the file system 412 contains enough space to complete the I/O operation. When the file system contains sufficient space, the I/O is completed as normal (step 505). Notably, I/O operations that do not require any storage space are completed without triggering the expansion steps of the invention. However, if it is determined that the space within the file system (or logical volume) is not sufficient to complete the I/O operation, the I/O is suspended and the I/O controller signals the I/O failure response (FR) daemon 404 (step 507).

The I/O FR daemon 404 executes a system call that triggers the LVM 402 (in application space 400) to increase the size of the logical volume (step 513) hosting the file system. The LVM checks whether there is sufficient reserve space on the volume group expand the logical volume and/or file system to accommodate the 110 (step 510). This check is important because expansion of the logical volume and file system is practical only when there is enough available space to support the I/O. If there is not enough reserve space, an I/O failure is messaged within the application level (step 511), and the process ends (step 513).

When there is sufficient reserve space, the LVM 402 increases the size of the logical volume (step 515). Then, the file system manager adjusts the file system parameters to include the additional space that is now available in the logical volume (step 517).

One example of commands that may be utilized within LVM 402 for completing this resizing of a logical volume and associated, active file system is provided below. According to the example, a logical volume (file system) named ReiserFS is being increased in size by 512 MB, and the commands utilized are:
lvextend−L+512M/dev/vg-name/lv-name
resize_reiserfs-s-512M/dev/vg-name/lv-name

In one embodiment, the size (i.e., number of bytes) by which the logical volume is increased is pre-established, and the LVM may include code for user manipulation of that parameter. Thus, the increase in step 515 allocates the pre-established (or default) amount of reserve space to the logical volume. This embodiment also includes a repeat of step 510 through step 515 until there is sufficient space in the file system to complete the I/O. In another embodiment, the I/O FR daemon 404 first determines the actual amount of space required, and if the amount required is greater than the default amount, the daemon 404 messages the LVM 402 to allocate two or more of the partitioned reserve spaces to complete the I/O operation. A third embodiment is also provided, which allocates at least an exact amount of space required. This third embodiment does not require partitioning of the reserve space into equal blocks. Each of the above embodiments are described in further detail in the example provided below.

Returning now to FIGS. 4 and 5, once the LVM 402 has completed the expansion of the logical volume and the file system expansion has completed, LVM 402 passes control back to the I/O FR daemon 404 (step 518). I/O FS daemon 404 then signals the I/O controller to trigger a re-start of the I/O at the kernel level. This re-start involves another check of available space to complete the I/O and scheduling of the I/O operation (step 520).

In one embodiment, a notification is generated and sent up to the application level to inform the user (or system manager) that a file system expansion was in process to complete the I/O operation (step 519). The notification may indicate the name of the file system, the size of the expansion, the amount of reserved space left within the volume group, etc. With this information, a system manager may later re-configure the volume groups, logical volumes, and/or file system and complete other management steps as necessary or desired.

Thus, rather than returning and displaying a general I/O failure message at the application level and terminating the I/O, the invention responds to the potential I/O (out-of-space) failure by: (1) increasing the size of the logical volume; (2) increasing the size of the file system; and (3) continuing the I/O operation at the kernel level without user input. Further, the invention (4) provides notification about the size increase of the file system.

Referring now to FIGS. 3B-3D, a specific example of the relative sizes of a logical volume and file system before and after an out-of-space I/O response is illustrated. FIG. 3B illustrates one of the logical volumes (LV3 303) from within the volume group 300 of FIG. 3A with an associated file system 321a. Also shown is the address space of reserve partition 304, with dashed lines indicating equal sub-partitions within reserve partition 304. Boundaries of LV 303 (with the associated file system 321a) and expansion/reserve partition 304a are illustrated with circled numerals 1 and 2 and 2 and 3, respectively, corresponding to similar numerals in FIG. 3A.

In the illustrative embodiments, the reserve space is shown as congruent to the logical volume so that expansion merely involves moving a shared boundary into space originally assigned to the reserve space. This implementation is provided solely for ease of description of the expansion steps of the invention, and the invention necessarily applies to non-congruent reserve spaces and logical volumes whose physical address space are not necessarily in a single physical block within the DASD.

With the example, LV3 303 and associated file system 321a are initially allocated 100 GB of space, all of which has been used. Reserve partition 304 comprises 100 MB divided into equal 10 MB blocks of space. With the example, a default amount of 10 MBs is established for each expansion operation. That is, the logical volume 303 and associated file system 321 are expanded by 10 MBs during each iteration.

The specific example covers a write operation to the file system by an application in user space. The write operation requires an increase of the file system's size by 15 MB. Thus, an I/O request is received that requires an additional 10 MB of space to complete, and I/O controller signals the I/O FR daemon, which signals the LVM to initiate an expansion of the logical volume 303. The LVM moves the boundary of the logical volume 303 by the default amount of 10 MB, incorporating some space of the reserve partition 304. Then, the file system manager increases the file system 321 by the additional 10MB space available in the logical volume.

Since the additional 10MB space is not sufficient for the I/O, a second expansion is completed (involving the above steps), and the file system is again increased by another 10 MB. This results in the file system having 20 MB of available space. Once the file system has the additional 10 MB of free space, the I/O is completed.

During expansion by the LVM, the end boundary of the logical volume 303b is extended to include a portion of the reserve space 304b as indicated by FIG. 3C. According to the example, this expansion would first expand LV 303 by 10 MB, and decrease the existing reserve space 304 by the same 10 MB. Boundary marker (2) is illustrated shifted into what was originally storage area of reserve space 304a. FIG. 3D illustrates the file system 321b after expansion into the new 20 MB space made available in LV 303b. The file system is thus expanded into the storage area originally part of reserve space 304, and the I/O operation is allowed to complete.

As explained above, a second embodiment determines that two blocks of space is required to complete the I/O and completes a single expansion of two blocks of reserve space. In the third embodiment, which calculates the total amount of space required, and completes a single expansion of that size. For example, since only an additional 15 MB are required, the I/O FR daemon messages the LVM to provide the additional 15 MB in a single expansion, and the LVM dynamically adjusts the boundaries (2) by only 15 MB.

The invention provides a self-managing, automatic I/O failure response system. I/O failures caused by out-of-space conditions are minimized because the invention allows both the volume and file system to be extended and the halted I/O to be automatically restarted without the application signaling an I/O error and terminating the I/O. The application (or user), therefore, does not see the I/O failure for out-of-space conditions that can be corrected. Accordingly, an application never fails with out-of-space I/O situations unless all available space on the volume group has been allocated.

It is important to note that while the present invention has been described in the context of a fully functional data processing system, those skilled in the art will appreciate that the mechanism of the present invention is capable of being distributed in the form of a computer readable medium of instructions in a variety of forms, and that the present invention applies equally, regardless of the particular type of signal bearing media utilized to actually carry out the distribution. Examples of computer readable media include: nonvolatile, hard-coded type media such as Read Only Memories (ROMs) or Erasable, Electrically Programmable Read Only Memories (EEPROMs), recordable type media such as floppy disks, hard disk drives and CD-ROMs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

1. In a computer system having I/O components and a file system existing within a volume group comprised of storage media, a method for substantially preventing I/O failure due to insufficient storage space within the file system, said method comprising:
determining that a received I/O operation directed at said file system requires more storage space than is currently available within said file system;
dynamically expanding the storage space available within said file system to accommodate said I/O operation, wherein additional space on said volume group is allocated to said file system; and
subsequently completing said I/O operation within said file system;
wherein said dynamically expanding step and said subsequently completing step are both completed without user input and/or activation.

2. The method of claim 1, wierein said dynamically expanding step includes assigning reserve storage space existing within said volume group to a logical volume hosting said file system.

3. The method of claim 1, wherein said subsequently completing step comprises restarting said I/O operation within kernel space without requiring user input.

4. The method of claim 1, further comprising issuing a notification indicating that said dynamically expanding step is being completed.

5. The method of claim 1, further comprising:
signaling a logical volume manager (LVM) of a need for additional storage space for completing said I/O;
completing an automatic expansion of a logical volume hosting said file system, wherein said dynamically expanding step expands said file system into available space within said logical volume following said automatic expansion.

6. The method of claim 5, wherein said signaling step is completed via an I/O failure response (FR) daemon that coordinates communication between control blocks in the kernel space and the LVM.

7. The method of claim 1, wherein said determining step comprises:
parsing parameters from said I/O command for a size of said storage space required to complete said I/O operation; and
comparing said storage space with an available storage space size within said file system.

8. The method of claim 1, wherein said dynamically expanding step comprises:
determining that said storage space is available within said reserve space; and
expanding said file system to include a preset amount of space from said reserve space.

9. The method of claim 5, wherein said expanding step includes iteratively expanding said file system by said preset amount of space until a total space within said file system is sufficient to accommodate said I/O operation.

10. The method of claim 1, wherein said dynamically expanding step comprises:
calculating an amount of additional space required to complete said I/O, with consideration of currently available space within said file system ; and
dynamically expanding said file system by at least said amount of additional space required.

11. In a computer system having I/O components and a file system existing within a volume group comprised of storage media, a system for mitigating I/O failure due to insufficient storage space within the file system, said system comprising:
means for determining that a received I/O operation directed at said file system requires more storage space than is currently available within said file system;
means for dynamically expanding the storage space available within said file system to accommodate said I/O operation, wherein additional space on said volume group is allocated to said file system; and
means for subsequently completing said I/O operation within said file system;
wherein said means for dynamically expanding and said means for subsequently completing both initiate without user input and/or activation.

12. The system of claim 11, wherein:
said means for dynamically expanding includes means for assigning reserve storage space existing within said volume group to a logical volume hosting said file system; and
said means for subsequently completing comprises means for restarting said I/O operation within kernel space without requiring user input.

13. The system of claim 11, further comprising means for issuing a notification indicating that said dynamically expanding step is being completed.

14. The system of claim 11, further comprising:
means for signaling a logical volume manager (LVM) of a need for additional storage space for completing said I/O; and
means for enabling said LVM to complete an automatic expansion of a logical volume hosting the file system, wherein said LVM signals said file system of a completion of said automatic expansion.

15. The system of claim 11, further comprising an I/O failure response (FR) daemon that coordinates communication between control blocks in the kernel space and the LVM.

16. The system of claim 11, wherein said means for dynamically expanding comprises:
means for determining that said storage space is available within said reserve space; and
means for expanding said file system to include a preset amount of space from said reserve space, wherein said means for expanding reiteratively expands said file system by said preset amount of space until a total space within said file system is sufficient to accommodate said I/O operation.

17. The system of claim 11, wherein said dynamically expanding step comprises:
means for calculating an amount of space required to complete said I/O given a value of currently available space within said file system; and
means for dynamically expanding said file system by at least said amount of space required.

18. The system of claim 11, wherein:
said means for determining includes I/O CC and OS functional logic;
said means for dynamically expanding includes said LVM; and
said means for notifying includes an I/O FR daemon that bridges communication between said I/O CC at an OS level and said LVM at an application level within said computer system.

19. A computer program product comprising:
a computer readable medium; and
computer program code on said computer readable medium for substantially preventing I/O failure due to storage space restrictions within a file system, said program code further comprising code for:
determining that a received I/O operation directed at said file system requires more storage space than is currently available within said file system;
dynamically expanding the storage space available within said file system to accommodate said I/O operation, wherein additional space on said volume group is allocated to said file system; and
subsequently completing said I/O operation within said file system.

20. The computer program product of claim 19, further comprising code for:
assigning reserve storage space existing within said volume group to a logical volume hosting said file system; and
restarting said I/O operation within kernel space without requiring user input;
wherein said code for implementing said dynamically expanding step and said subsequently completing step are executed without user input and/or activation..

21. The computer program product of claim 19, further comprising code for:
implementing an I/O failure response (FR) daemon that coordinates communication between control blocks in the kernel space and the LVM, wherein said I/O FR completes a set of functional operations including:
signaling a logical volume manager (LVM) of a need for additional storage space for completing said I/O;
issuing a notification indicating that said dynamically expanding step is being completed; and
initiating a restart of said 110 operation once said expansion completes;
wherein said LVM completes an automatic expansion of a logical volume hosting said file system, and said dynamically expanding step expands said file system into available space within said logical volume following said automatic expansion.

22. The computer program product of claim 19, wherein said code for determining comprises additional code for:
parsing parameters from said I/O command for a storage space required to complete said I/O operation; and
comparing said storage space with an available storage space within said file system.

23. The computer program product of claim 19, wherein said code for dynamically expanding comprises code for:
determining that said storage space is available within said reserve space;
expanding said file system to include a preset amount of space from said reserve space; and
iteratively expanding said file system by said preset amount of space until a total space within said file system is sufficient to accommodate said I/O operation.

24. The computer program product of claim 19, wherein when there is not sufficient space within said reserve space, said code comprises additional code for signaling a complete failure of said I/O operation.

25. The computer program product of claim 16, wherein said code for dynamically expanding step comprises:
code for calculating an amount of space required to complete said I/O given a value of currently available space within said file system; and
code for dynamically expanding said file system by at least said amount of space required.
